(19) United States
(12) Patent Application Publication
(10) Pub. No.: US 2003/0026535 A1
(43) Pub. Date: Feb. 6, 2003

(54) Optical fiber collimators and their manufacture

(76) Inventor: Ljerka Ukrainczyk, Painted Post, NY (US)

Correspondence Address: CORNING INCORPORATED, SP-TI-3-1, CORNING, NY, 14831

(21) Appl. No.: 09/919,139

(22) Filed: Jul. 31, 2001

(51) Int. Cl. G02B 6/32; G02B 6/38

(52) U.S. Cl. 385/33; 385/61

(57) ABSTRACT

An optical fiber collimator includes a transparent rod having a diameter large compared with the core diameter of the fiber but small compared with the lens. A first fusion splice connects the optical fiber to one end of the transparent rod and a second fusion splice connects the second end of the rod to the lens.

The first fusion splice is thus relatively small and can be made with good precision (in particular, the mode field at the splice position can be kept closely circular and its diameter accurately controlled); the second fusion splice does not require such high precision because its diameter is large compared with the mode field diameter at its position, and so does not affect it, nor the mode field in the light path beyond the preformed component.

The invention is especially useful for collimators of large diameters such as are used (for example) with some types of optical switch.

### CROSS-REFERENCES TO RELATED APPLICATIONS

Not applicable

### STATEMENT REGARDING FEDERALLY SPONSORED RESEARCH & DEVELOPMENT

Not applicable

### REFERENCE TO A MICROFICH APPENDIX

Not applicable

### BACKGROUND OF THE INVENTION

Field of the Invention

This invention relates to optical communications and more specifically to optical fiber collimators and a process for their manufacture.

### DESCRIPTION OF THE RELATED ART INCLUDING INFORMATION

DISCLOSED UNDER 37C. F. R. 1.97 AND 1.98

Light must emerge from the end of an optical fiber in the form of a diverging beam, and a lens normally has to be used immediately to convert this to a substantially parallel or slightly converging beam. Gradient index, refractive or diffractive lenses, or of course arrays of like or different lens types, can be used. The assembly of a fiber end with a lens for producing an at least approximately parallel beam from light emerging from the fiber is called a “collimator”, and if the light is subsequently to be re-launched into another optical fiber, a second collimator operating in a reverse sense will be needed.

Naturally, the lens must have a diameter larger than that of any part of the beam that is to pass through it and in some cases, for example when the beam is to be controlled by a liquid crystal switching device, the beam needs to have a cross-section much larger than that of the core of the optical fiber, so implying that the lens will often need to be quite large compared with the diameter of the fiber. This creates difficulties in connecting the fiber to the lens by fusion splicing, which is desired for reliability and long-term stability of the connection. The lens will conduct substantial amounts of heat away from the fusion zone, increasing the amount of energy that must be input, and at the same time it is liable to get in the way of delivering the required energy efficiently and precisely.

Use of an arc, flame or hot filament as heat source is more or less precluded, and while laser fusion splicing is possible, there is risk that the quantity of heat energy delivered and/or its spacial distribution may not be precisely correct, with the consequence that the diameter of the fiber core at the interface may not be reproducible and its cross-section may be unintentionally non-circular. Variations in physical dimensions at the interface are reflected in the mode field of the fiber (the part of the cross-sectional area within which 1/e^{2,} or about 86%, of the total luminous flux is contained) at the splice position; such variations are enlarged by the optics and may produce unacceptable deviations from the intended convergence of the collimator and from the intended diameter and cross-sectional shape of the beam that it produces.

### BRIEF SUMMARY OF THE INVENTION

The invention provides a collimator and a method of making it in which the mode field diameter and circularity at the fiber interface can be better controlled, with the advantage that the optical properties of the collimator may be more precisely controlled and (when like assemblies are being made in succession) more consistent.

The invention provides an optical fiber collimator comprising a collimating lens which comprises at least one lens element bonded to-an end of an optical fiber and distinguished by a transparent rod having first and second ends and a diameter large compared with the core diameter of said fiber; a first fusion splice between said optical fiber and said first end of said transparent rod; and a second fusion splice between said lens element and said second end of said fiber.

The invention also provides a method of making an optical fiber collimator by bonding an element of a collimating lens to an end of an optical fiber and distinguished by providing a transparent rod having first and second ends and a diameter large compared with the core diameter of said fiber; forming a first fusion splice between said optical fiber and said first end of said transparent rod; and forming a second fusion splice between said lens element and said second end of said fiber.

The fiber may be a single mode or a multimode fiber and (as already indicated) any suitable type of lens can be used, provided that the material of at least the specified element (the element next to the fiber) is compatible for fusion-bonding with the fiber. Usually the fiber and the said lens element will be made of silica and/or another glass, but any suitable material or combination of materials can be used. Single-element lenses may be refractive, diffractive or graded-index lenses while a lens array could include elements of more than one of these categories, and may include elements that, individually, have either positive or negative optical power. In particular, a negative-power element may be used as the specified element to be fusion-bonded to the fiber if it is desired to obtain a large increase in beam diameter in a short distance.

The transparent rod is preferably of circular cross-section (at least at its first end) and conveniently of uniform shape and diameter from end to end, though it might (for example) taper from a least diameter at its first end to a greatest diameter at its second end. It will usually have a diameter larger than the overall diameter of the optical fiber, but in some cases a diameter equal to it or even somewhat smaller may be sufficient. Its diameter could be smaller than, equal to or larger than the diameter of the lens, but it is usually preferable for it to be smaller, or at least not larger. A plain rod of uniform refractive index is satisfactory and preferred, but a short length of clad optical fiber could be used provided its diameter is sufficiently large that the light beam diverging through it will be wholly contained within its core. In general, the length of the rod must not exceed the value

Lₘₐₓ=0.5D/tanθ

where D is the (optically accessible) diameter of the rod and θ is the acceptance angle of the fiber. The 1/e² beam radius of the beam emerging from the end of the rod is given by the formula

w=w₀[1+(Lλ/nπw₀²)²]^{0.5}

where w₀ is the Gaussian beam radius of the fiber mode field, L is the length of the rod, λ is the wavelength and n the index of refraction of the rod.

The transparent rod may be pre-cut to the required length, but especially if it is to be short and so may be difficult to manipulate we prefer to splice a longer piece of rod to the fiber (or alternatively to the lens) and then use one of the conventional techniques of taper-cutting or cleaving to obtain the desired rod length.

If the thermal expansion coefficients of the fiber and lens are similar, the transparent rod preferably has a similar thermal expansion coefficient: if and to the extent they may differ, the transparent rod preferably has a thermal expansion coefficient intermediate between those of the fiber and the lens.

The first fusion splice between the transparent rod and the fiber differs comparatively little from a fiber-to-fiber splice, and should be made with a well-controlled precision splicer, preferably of the heated-filament type; the second fusion splice between the rod and the lens may be made by any type of fusion splicer with adequate access and power and a normal standard of control, since it does not influence the mode field diameter of the collimator: a laser fusion splicer is recommended.

### BRIEF DESCRIPTION OF THE SEVERAL VIEWS OF THE DRAWINGS

FIG. 1 is a diagram of a fiber optic system including two collimators;

FIG. 2 is a graph showing the variation of mode field diameter of a particular collimator for various fiber interface mode field diameters;

FIG. 3 is a diagrammatic elevation of an optical fiber collimator in accordance with the invention; and

FIG. 4 is a diagram of an optical switching assembly incorporating two optical fiber collimators in accordance with the invention.

### DETAILED DESCRIPTION OF THE INVENTION

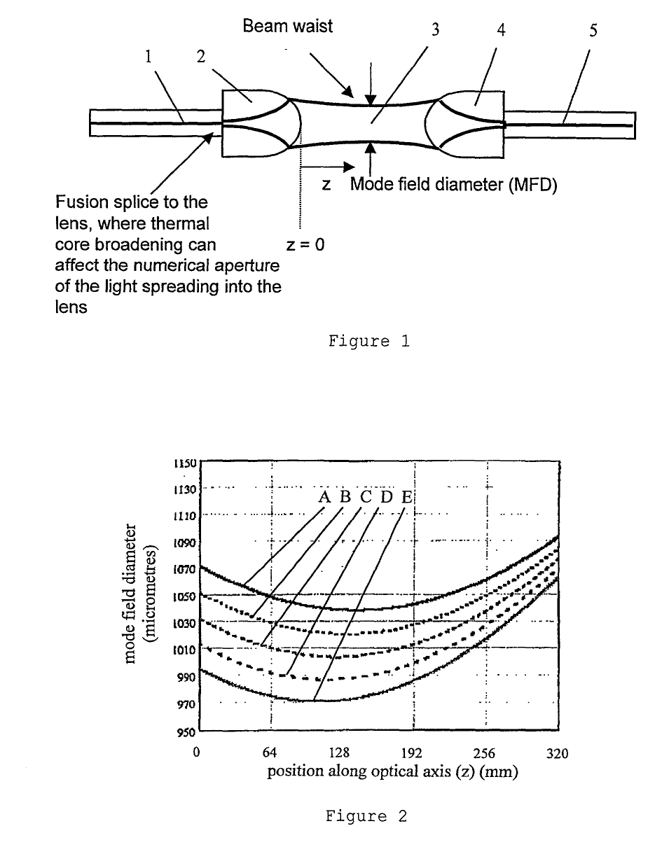

FIG. 1 shows two conventional fiber optic collimators assembled so that light emerging from one of them is re-launched into the fiber of the other. Depending on the application, other optical components of many kinds may be interposed between the two collimators. For purpose of illustration, say that light enters from the left of the figure by a first optical fiber 1 and is delivered (preferably without passing through an airspace or adhesive) into a first collimating (effectively planoconvex) lens 2 with a focal length such that it emerges as a nominally parallel beam. In practice, the beam passes through a “waist” 3 because of diffraction effects and optical imperfections, and if the position of the waist and its mode field diameter vary unpredictably, it is not possible to optimize the converging power and exact position of the second collimator lens, and the coupling efficiency will inevitably be degraded. If the mode field is non-circular, further degradation of coupling efficiency results.

The position and diameter of the waist are significantly affected by the dimensions of the mode field boundary at the end of the fiber 1 and the shape of the mode field at any point in the beam is largely determined by it. FIG. 2 illustrates the effect of dimensional variation by graphing the mode field diameter as a function of axial position (z, measured from the convex face of the lens) in the neighborhood of the waist for a particular collimator based on silica glass optics in which the convex faces of the lenses have a radius of curvature of 2.5 mm and they are 8.15 mm thick. Curves A, B, C, D and E are respectively for mode field diameters at the fiber end of 10.4, 10.6, 10.8, 11.0 and 11.2 μm.

Even over this relatively small variation of fiber-end mode field diameters, the graph shows that the collimator waist mode field diameter ranges from about 970 to 1040 μm and its axial position varies by about 33 mm. Such variations at best mean that major adjustments to spacing are needed if the beam is to be correctly coupled into output fiber.

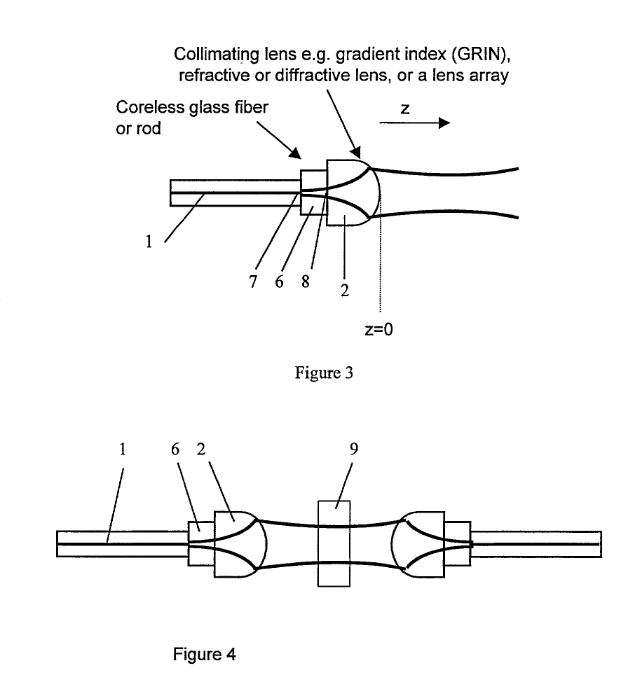

In accordance with the invention (FIG. 3) a transparent rod 6 is interposed between fiber 1 and lens 2 and spliced to them respectively by a first fusion splice 7 and a second fusion splice 8. The first fusion splice 7 is relatively easy to make with precision, since the diameter of the rod 2 is in this example only a few times the diameter of fiber 1. We prefer to use a fusion splicer of the kind that uses a filament loop as heat source such as the one currently marketed under the designation Vytran FFS 2000.

After preparing the free end of the rod 6, if necessary, by cleaving or taper cutting to a suitable length (for example about 1 mm for a 200 μm rod), the second fusion splice 8 to the lens 2, also of pure silica, can be made with any fusion splicer of adequate capacity: no special precision is needed, because at this point the mode field diameter is wholly contained within a small central area of the splice, where the glass composition and refractive index is uniform, and is not influenced by the position or shape of the periphery of the splice. Furthermore, the length of the rod 6 is ample to ensure that the heat applied to form the second splice will not raise the temperature of the first splice to a level at which it might distort.

It will be understood that the order in which the two fusion splices are made is not critical, so that the rod might be spliced first to the lens or other preformed component if preferred.

FIG. 4 schematically illustrates one pass-through channel of an optical switch in accordance with the invention; it is basically like the assembly shown in FIG. 1 except for the insertion of a glass rod 6, as described, between the fiber and lens at each end and the selection of a switching module 9 as an interposed active optical component; the switching module 9 may equally be a liquid crystal cell or a pop-up MEMS (Micro-Electro-Mechanical System) mirror.

### EXAMPLE

A typical silica-based single mode communications fiber with core and cladding diameters of about 9 μm and 125 μm respectively was fusion-spliced to one end of a pure silica rod with a diameter of 200 μm using a Vytran FFS 2000 splicer. The length of the rod was several centimeters. The rod was then cleaved to a length of 1.0 mm using a commercially available cleaver; alternatively, it could be taper cut by positioning the filament hot-zone of the splicer to the position of the desired cut and pulling on the rod while applying heat from the filament, and in either case the end face could be polished for better surface finish. The beam diameter (at 1/e²) where it emerges from the end of the rod is expanded to 110 μm. The rod was next fusion spliced to the flat face of a silica plano-convex lens with a radius of curvature of 2.5 mm, thickness of 7.15 mm, and diameter of 1.5 mm using a commercial laser fusion splicer. Since the mode field diameter of the fiber at the splice to the rod was closely controlled, the process could be repeated to produce a series of collimators in which the mode field diameter and waist position of the emerging beam were almost identical.

Any discussion of the background to the invention herein is included to explain the context of the invention. Where any document or information is referred to as “known”, it is admitted only that it was known to at least one member of the public somewhere prior to the date of this application. Unless the content of the reference otherwise clearly indicates, no admission is made that such knowledge was expressed in a printed publication, nor that it was available to the public or to experts in the art to which the invention relates in the US or in any particular country (whether a member-state of the PCT or not), nor that it was known or disclosed before the invention was made or prior to any claimed date. Further, no admission is made that any document or information forms part of the common general knowledge of the art either on a world-wide basis or in any country and it is not believed that any of it does so.

What we claim is:

1. An optical fiber collimator comprising a collimating lens which comprises at least one lens element bonded to an end of an optical fiber and distinguished by a transparent rod having first and second ends and a diameter large compared with the core diameter of said fiber; a first fusion splice between said optical fiber and said first end of said transparent rod; and a second fusion splice between said lens element and said second end of said fiber.

2. An optical fiber collimator according to claim 1 in which said transparent rod is of circular cross-section at least at its first end.

3. An optical fiber collimator according to claim 1 in which said transparent rod is of uniform shape and diameter from end to end.

4. An optical fiber collimator according to claim 1 in which said transparent rod has a diameter larger than the overall diameter of said optical fiber.

5. An optical fiber collimator according to claim 1 in which the transparent rod is of uniform refractive index.

6. An optical fiber collimator according to claim 1 in which said transparent rod, said fiber and said lens have substantially equal thermal expansion coefficients.

7. An optical fiber collimator according to claim 1 in which said fiber and said rod have different thermal expansion coefficients and said transparent rod has a thermal expansion coefficient intermediate between those of the fiber and the lens.

8. An optical fiber collimator according to claim 1 in which said collimating lens consists of the said element only.

9. A method of making an optical fiber by bonding an element of a collimating lens to an end of an optical fiber and distinguished by providing a transparent rod having first and second ends and a diameter large compared with the core diameter of said fiber; forming a first fusion splice between said optical fiber and said first end of said transparent rod; and forming a second fusion splice between said lens element and said second end of said fiber.

10. A method in accordance with claim 9 in which said transparent rod is pre-cut to length.

11. A method in accordance with claim 9 in which said transparent rod is cut to length after splicing to said fiber.

12. A method in accordance with claim 9 in which said transparent rod is cut to length after splicing to said lens.

13. A method in accordance with claim 9 in which said first fusion splice is made with a precision splicer of the heated-filament type.

14. A method in accordance with claim 9 in which said collimating lens comprises only said lens element.
